(19) United States
(12) Patent Application Publication
(10) Pub. No.: US 2019/0267811 A1
(43) Pub. Date: Aug. 29, 2019

(54) METHOD AND SYSTEM FOR GENERATION AND DISTRIBUTION OF HIGH VOLTAGE DIRECT CURRENT

(71) Applicant: R-Stor Inc., Saratoga, CA (US)

(72) Inventors: Pierluigi SARTI, Milpitas, CA (US); Giovanni COGLITORE, Saratoga, CA (US)

(21) Appl. No.: 16/288,778

(22) Filed: Feb. 28, 2019

Related U.S. Application Data
(60) Provisional application No. 62/636,424, filed on Feb. 28, 2018.

(51) Int. Cl. H02J 3/36; H02J 3/12; H02M 7/757

(52) U.S. Cl. CPC H02J 3/36; H02J 2003/365; H02M 7/7575; H02J 3/12

(57) ABSTRACT

A system for generation and distribution of high voltage direct current (HVDC) within a contained power domain named ‘POD’ and methods for making and using the same. The system and methods efficiently power Information Technology racks deployed to a data center environment, advantageously providing features and functions highly desirable for a specific application.

### CROSS-REFERENCE TO RELATED APPLICATIONS

This application claims the benefit of, and priority to, U.S. Provisional Application Ser. No. 62/636,424, filed on Feb. 28, 2018, the disclosure of the provisional application is hereby incorporated by reference in its entirety and for all purposes.

### FIELD

The present disclosure relates to power electronics, and more specifically, but not exclusively, to a system and method for generation and distribution of high voltage direct current (HVDC) within a contained power domain.

### BACKGROUND

A data center is a contained and controlled environment where server, storage, and networking gears run grouped in racks (e.g., commonly 19″ Electronic Industries Association (EIA) racks also known as “standard racks” following EIA-310 specifications) lined up in data center rows. These rows are normally powered by Alternative Current (AC) (from power grid) distributed throughout the data center at various voltage levels depending on locations. This internal data center power distribution is supported by a centralized (or in-row) Alternative Current Uninterruptible Power Supply (AC UPS), to guarantee the supply of AC power to the server racks during external forces including AC power grid outages, dips, sags, and power line disturbances. Data centers deploy and operate racks to match business needs, such as for an Information technology (IT) capacity. IT racks need to be continuously powered and service must not be interrupted by those external forces.

Conventionally, following an AC power grid outage, data center emergency generators (e.g., GenSet) startup to provide AC power again until the grid becomes available again; however, there is some latency before the generators get online. Accordingly, in the meantime, IT racks run using energy from batteries. Normally, the batteries do not last long (typically less than a few minutes)—only enough for the generators to start and get online. Once online, the generators might stay ON for hours and/or days, depending on the wait for the normal AC power grid to get back online.

Similarly, conventional IT racks may temporarily use high levels of power (higher than rack power rating), for example, during random repetitive ‘peaks’ or ‘surges’ resulting from microprocessors engaging ‘TURBO’ functions and/or similar temporary higher power functions. This may not be easy to handle since power availability to each rack is limited by their own source rating and breaker. Normally the power provisioning for a data center row is approximately the sum of nominal power rating of the racks in the row. Therefore, the row normally cannot handle load peaks above that sum.

Any power solution making use of local batteries for backup can include extraneous functionalities, provided that topology allows to share the energy from the batteries with the energy from the AC grid. For ‘Surge Mode’ (and consequently ‘Peak Shaving’ of the AC powering the rack) to work properly, large (or very large) battery banks may be needed; otherwise, these functions may be compromised by the quick discharge rate of the batteries.

Conventional approaches avoid using high voltage direct current due to safety aspects and limited availability of standard compatible components on the load side: for example, commercially available IT racks are powered from the AC grid with an AC plug, and are not available powered from high voltage direct current (HVDC) with a DC plug.

In view of the foregoing, a need exists for an improved system for electrical power design and distribution in an effort to overcome the aforementioned obstacles and deficiencies of conventional power systems.

### BRIEF DESCRIPTION OF THE DRAWINGS

FIG. 1 is an exemplary top-level block diagram illustrating one embodiment of a power management system for electrical power design and distribution.

FIG. 2 is an exemplary top-level block diagram illustrating another embodiment of the power management system of FIG. 1.

FIG. 3 is an exemplary top-level block diagram illustrating one embodiment of a power stack assembly using the power management system of FIG. 1.

FIG. 4 is an exemplary top-level block diagram illustrating one embodiment of the breakers of the power management system of FIG. 3.

FIG. 5 is an exemplary top-level block diagram illustrating one embodiment of the switches of the power management system of FIG. 3.

FIG. 6 is an exemplary top-level block diagram illustrating another embodiment of the power management system of FIG. 1 with hardware blocks and a wire layout.

FIG. 7 is an exemplary top-level block diagram illustrating another embodiment of the power management system of FIG. 1.

FIG. 8 is an exemplary top-level block diagram illustrating another embodiment of the power management system of FIG. 1.

FIG. 9 is an exemplary top-level block diagram illustrating another embodiment of the power management system of FIG. 1 with circuit diagrams.

FIG. 10 is an exemplary top-level block diagram illustrating one embodiment for coupling the batteries with the discharger of the power management system of FIG. 1.

FIG. 11 is an exemplary top-level block diagram illustrating another embodiment for coupling the batteries with the discharger of the power management system of FIG. 1.

FIG. 12 is an exemplary chart illustrating one embodiment of the voltage as a function of time for each battery of the power management system of FIG. 1.

FIG. 13 is an exemplary chart illustrating one embodiment of the current-voltage (IV) characteristic of the system power domain of FIG. 1 during a surge mode.

FIG. 14 is an exemplary chart illustrating one embodiment of the current-voltage (IV) characteristic of the system power domain of FIG. 1 during a backup mode.

FIG. 15 is an exemplary circuit diagram illustrating one embodiment of the charger of the power management system of FIG. 1.

FIG. 16 is an exemplary top-level diagram illustrating one embodiment of a digital interconnection topology for a high voltage direct current (HVDC) cabinet using the power management system of FIG. 1.

FIG. 17 is an exemplary top-level diagram illustrating another embodiment of a digital interconnection topology for a high voltage direct current (HVDC) cabinet using the power management system of FIG. 1.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

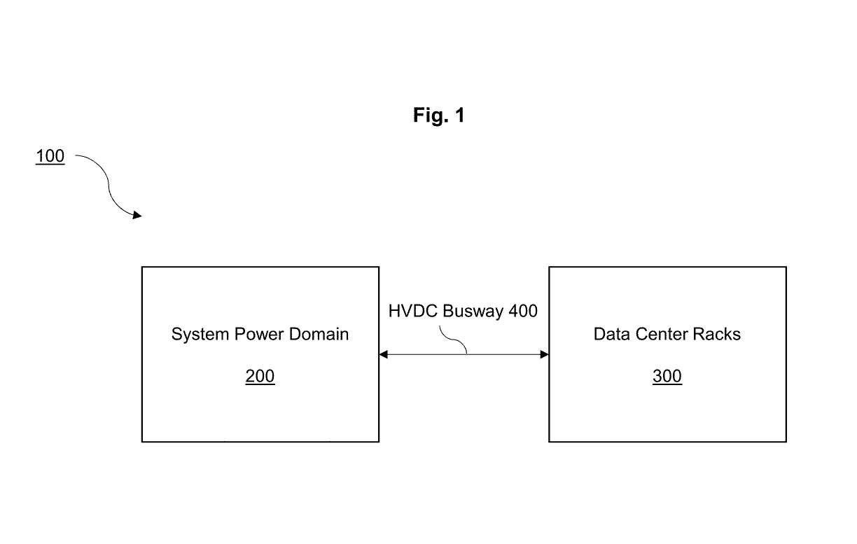

Since currently-available power management systems are deficient because of the need to use high levels of power and latency delays from alternating current (AC) power grid outages, dips, sags, and power line disturbances, a system for improved electrical power design and distribution can prove desirable and provide a basis for a wide range of power management applications, such as for efficiently powering information technology (IT) racks deployed to data center environment, data center infrastructures, hyperscale scale data centers, IT environments, and providing features and functions highly desirable for the specific application. Additionally, the systems disclosed herein provide the advantage to be a very effective solution for capital expenditures, operating expenses, and for cost amortization over time. This result can be achieved, according to one embodiment disclosed herein, by a power management system 100 as illustrated in FIG. 1.

Turning to FIG. 1, the power management system 100 includes a system power domain 200 powers one or more data center racks 300. The power management system 100 advantageously moves a front-end portion of in-rack power converters into a data center infrastructure, such as the system power domain 200, thereby simplifying the in-rack power solution. In other words, the power management system 100 embodies a high voltage direct current (HVDC) power distribution approach. As shown, the system power domain 200 consolidates server power outside of the data center racks 300 to decrease stranded power and improving peak demand performance of the data center racks 300. Each system power domain 200 can individually power at least one data center rack 300. Additionally and/or alternatively, each system power domain 200 can limit the number of the data center racks 300 that are supported as desired.

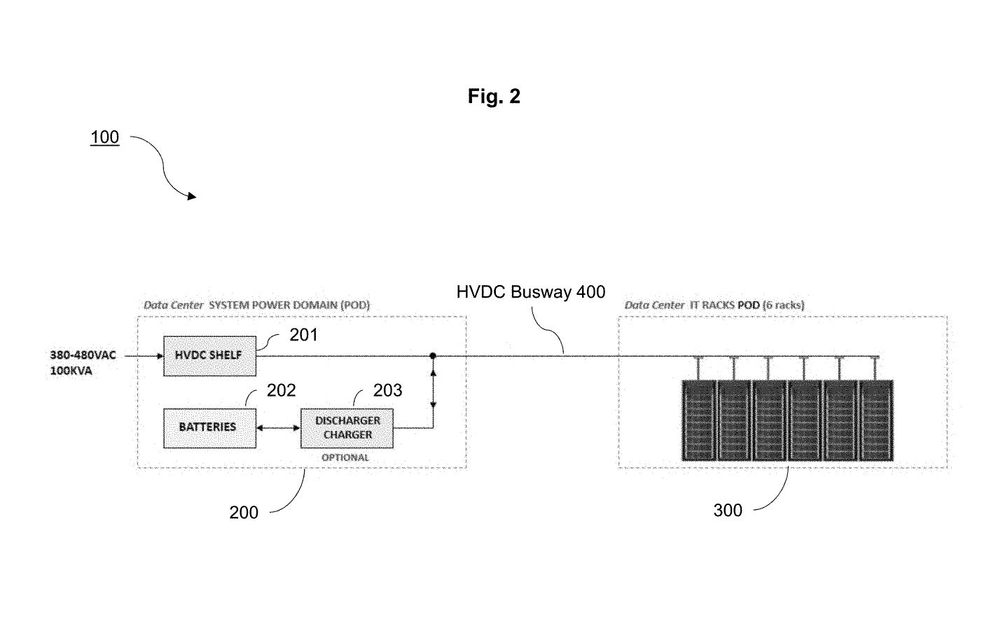

Turning to FIG. 2, an exemplary embodiment of the power management system 100 is illustrated in further detail. As shown, an HVDC can be produced from an AC power grid using redundant high-power converter ‘rectifiers’, such as an HVDC shelf 201 connected to one or more batteries 202. A power domain (known herein as a ‘POD’) is a power circuitry and electrical distribution system dedicated to individually power a predetermined number of racks (e.g., IT racks). The power converter that generates the HVDC to power the POD receives the input energy from the regular AC grid. With reference to FIG. 2, the HVDC shelf 201 and the batteries 202 power the data center racks 300 belonging to a domain ‘Power POD’. By way of example, the AC power grid provides 380-480 VAC input to power the HVDC shelf 201, which generates at least 380 VDC to a HVDC busway 400. The HVDC busway 400 can power IT racks belonging to the same Power POD with limited loss of efficiency. In the example shown in FIG. 2, six IT racks are included in the data center rack 300. Although shown and described as a single data center rack 300, the example shown in FIG. 2 can also represent a portion of a selected data center row within a data center.

The batteries 202 can keep service during AC input power grid outages (for minutes) and seamlessly compensate during AC grid sags/hiccups/disturbances. In some embodiments, the batteries 202 can include one or more Lithium Ion (Li-Ion) battery backup units (BBUs) that are coupled to the HVDC busway via intermediate converters 203 used to regulate voltage when BBUs discharge to the HVDC busway, share BBU output currents, enable “surge mode” functions, and charge BBUs. In other words, the batteries 202 can keep service during AC grid outages and seamlessly compensate for grid disturbances, sags, and so on. In some embodiments, the intermediate converters 203 can include one or more chargers and/or one or more optional dischargers. Although shown and described as separate functional units, those of ordinary skill in the art would understand that the intermediate converters 203 can reside on the same platform and/or circuitry as the batteries 202. By way of example, a charger circuit can reside directly inside each of the batteries 202.

In some embodiments, additional value is provided by this design such as ‘peak sharing’, ‘surge mode’, and ‘peak shaving’.

Peak sharing is the capability of the data center rack 300 to operate at power levels above its maximum source rating, as long as the system power domain POD (where the rack belongs to) stays below its maximum power rating. During peak sharing, the batteries 202 are not required.

Surge mode is the capability of the system power domain 200 to operate at power levels above its maximum rating and source rating. During ‘surge mode power peaks,’ the extra energy is supplied by the batteries 202. Individual rack power peaks may be as high as +50% nominal. In some embodiments, an in-rack power solution can be used to handle the additional power peaks as desired.

Peak shaving is an indirect effect of the surge mode. Specifically, during surge mode, the input energy from the AC grid can be capped (load power peaks are not transferred to the AC grid).

Electrical efficiency of the overall power distribution and conversion is comparable (or exceeds) best AC approaches. By way of example, best AC approaches are defined in the standardized server system specifications for scale computing of the Open Compute Project (OCP) Server Project.

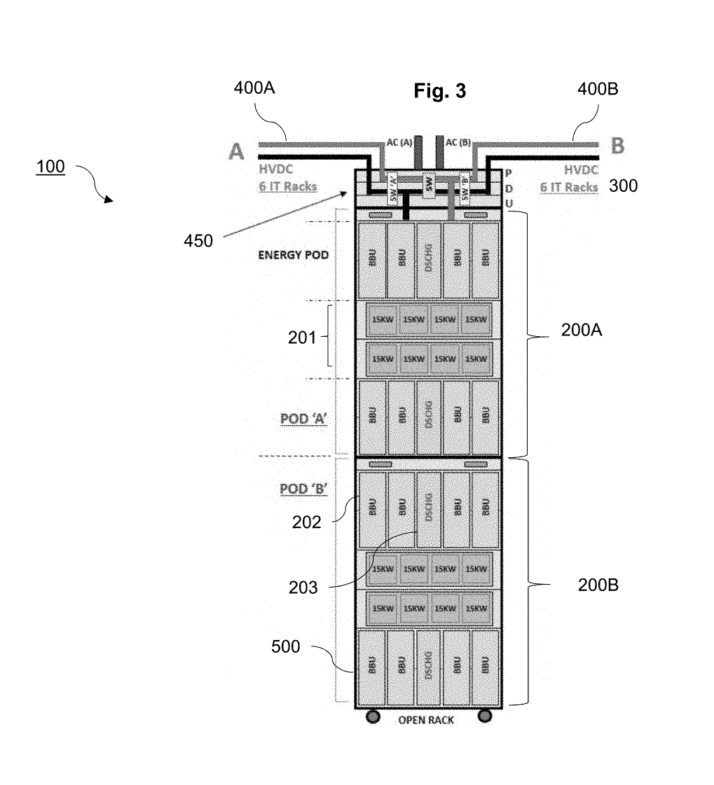

Turning to FIG. 3, in an exemplary embodiment, a cabinet 500 can be permanently deployed in the middle of a data center row, with symmetric split HVDC power distribution lines to limit power distribution losses. In some embodiments, the cabinet 500 is a mechanical Open Rack (e.g., an Open Compute Project (OCP) rack) and hosts two independent system power domains 200 (e.g., POD A (system power domain 200A) and POD B (system power domain 200B), shown in FIG. 3)—each one powering a predetermined number of IT racks (six data center racks 300 in this example). The Open Rack advantageously includes one or more OpenU (OU) slot sizes (e.g., 3×48 mm=144 mm) having more vertical slot space compared to conventional rack slots (e.g., EIA-310 racks). The Open Rack is robust and includes at least two top-slots for a HVAC input and an HVDC output connection. All power components, including the batteries 202 are doubled in the cabinet 500, to create two independent and isolated HVDC outputs (e.g., 2×380 VDC or 2×±190 VDC), powering two independent and isolated HVDC busway 400 (e.g., HVDC busway 400A and HVDC busway 400B) distribution systems in the data center row; one POD for the racks grouped to the left side of the cabinet (e.g., 6 racks) and one POD for the racks grouped to the right side of the cabinet (e.g., 6 racks). This design increases reliability and redundancy, and advantageously limits maximum power within each POD. In fact, excessive energy levels assigned to a power domain typically are not desired, especially when batteries are involved.

By way of example, the batteries 202 of FIG. 3 can include one or more BBUs, such as one or more hot-swap module 96s3p Li-Ion battery units (i.e., 96 Li-Ion cells in series, 3 above arrays in parallel to yield 288 total Li-Ion cells in each BBU). The intermediate converters 203 can include one or more optional dischargers, such as one or more discharge hot-swap module 45 KW with four-channels (e.g., 3+1 step-up non-isolated power converters), each handling four BBUs. As shown in FIG. 3, each system power domain 200 includes eight batteries 202 and two optional dischargers (e.g., the intermediate converters 203). In some embodiments, each BBU and each optional discharger (e.g., the intermediate converter 203) is about 25″ (635 mm) in size. The batteries 202 and the optional discharger (e.g., the intermediate converter 203) together can be rated 45 KW having a redundancy of over 8 BBUs per group of two system power domains 200. The HVDC rack 201 can be rated 105 KW, with a redundancy over 8 power modules per system power domain 200.

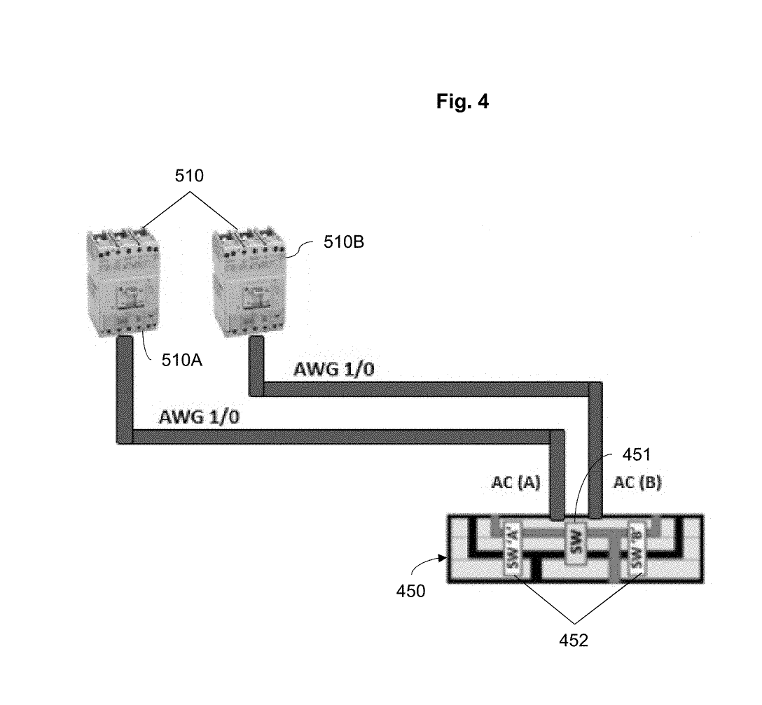

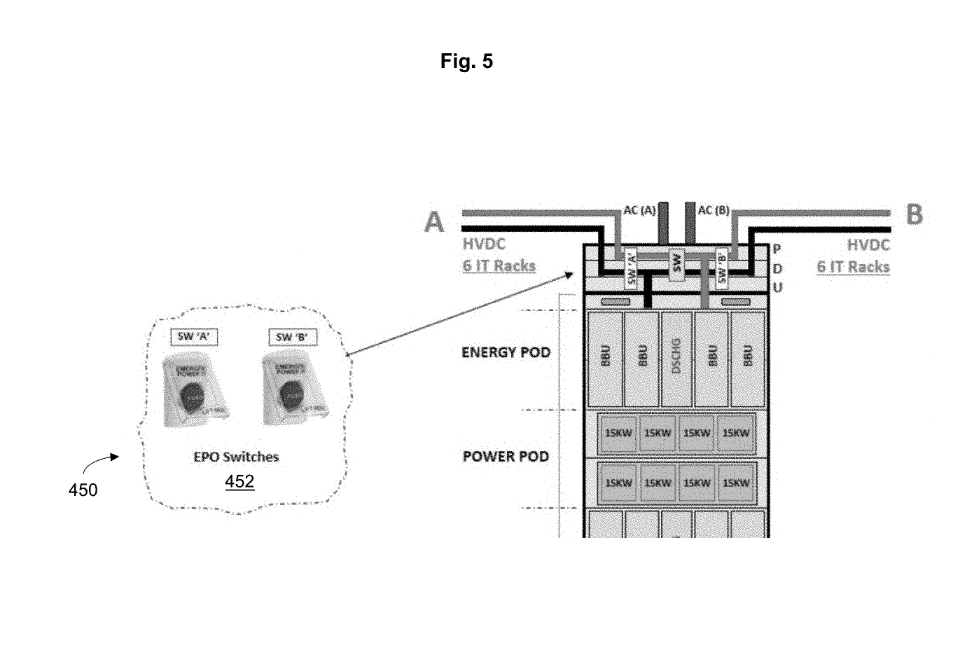

An AC power grid (e.g., a three-phase 380 VAC or 480 VAC) powers a first POD (e.g., the system power domain 200A) through a redundant high-power conversion stage, consolidated and installed to a separate cabinet within the cabinet 500 together with its own set of batteries 202. As shown in closer detail in FIGS. 4 and 5 (and the top portion of FIG. 3), two AC inputs can be individually hard-wired to two independent AC breakers 510 at a data center breaker panel, for example, each having a minimum rating of 150 A at 480 VAC. Four wire cables pair to be a high-power cable, such as a one aught wire (I/O) according to American Wire Gauge standards.

The power management system 100 can include one or more switches 450. With reference to FIGS. 4-5, during a backup sequence following an AC outage, a solid-state switch (SW) 451 can be used to interconnect the two system power domains 200A/B during discharge of a battery backup (e.g., the batteries 202). In other words, the solid-state switch 451 dynamically interconnects the system power domain 200A and the system power domain 200B within the cabinet 500 after a backup sequence has started in both system power domains 200A/B. In this situation, both input AC feeds need to drop together for the solid-state switch 451 to close. Accordingly, the solid-state switch 451 can optimize the usage of all batteries 202 deployed in the cabinet 500, thereby maximizing the total backup duration. In some embodiments, the solid-state switch 451 is installed in the cabinet 500. The solid-state switch 451 can be a bi-directional solid-state switch having a 45 KW rating, driven by two isolated signals from both system power domains 200A/B. During any AC operations, this solid-state switch 451 can be always open. Stated in another way, if any AC is present from either system power domain 200A/B, the solid-state switch 451 is open.

As also shown in FIG. 5, each system power domain 200 can include one or more of the switches 450, such as respective soft switches 452 (e.g., SW A and SW B). These switches 452 can shut down corresponding system power domains (e.g., the system power domain 200A or 200B). These switches 452 are neither breakers nor a mechanical switch, but can be any solid-state switch for turning off the associated batteries 202 and the associated HVDC shelf 201 for the respective system power domain 200. Each soft switch 452 can be commanded manually and/or by an independent and isolated open collector analog signal that can be routed outside the control panel (not shown) of the data center 300 to enable remote emergency power off (EPO) functionality. If either switch is in an “off” position, the solid-state switch 451 can also be disabled.

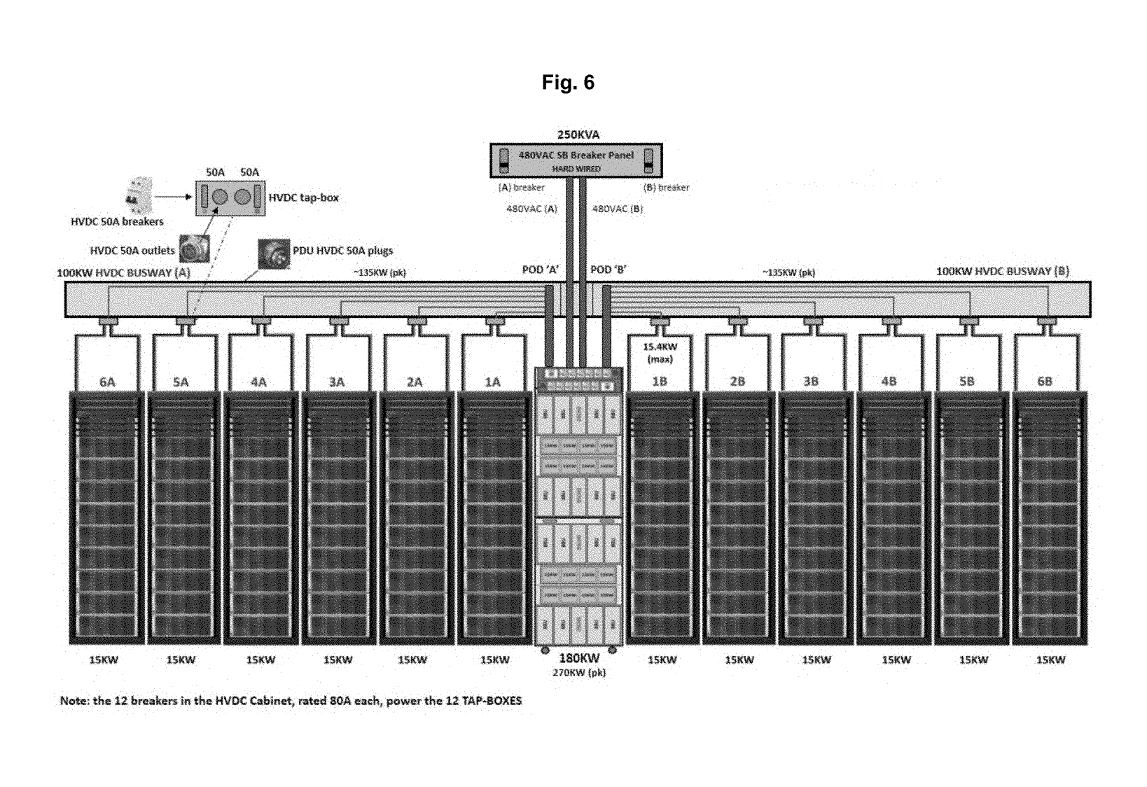

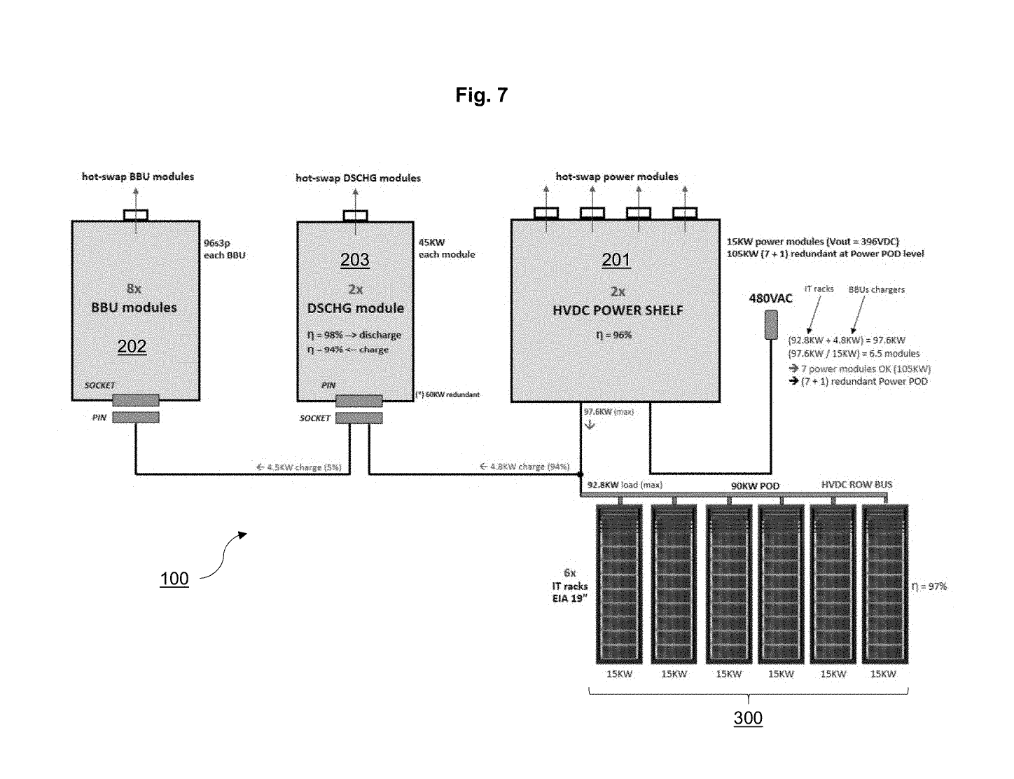

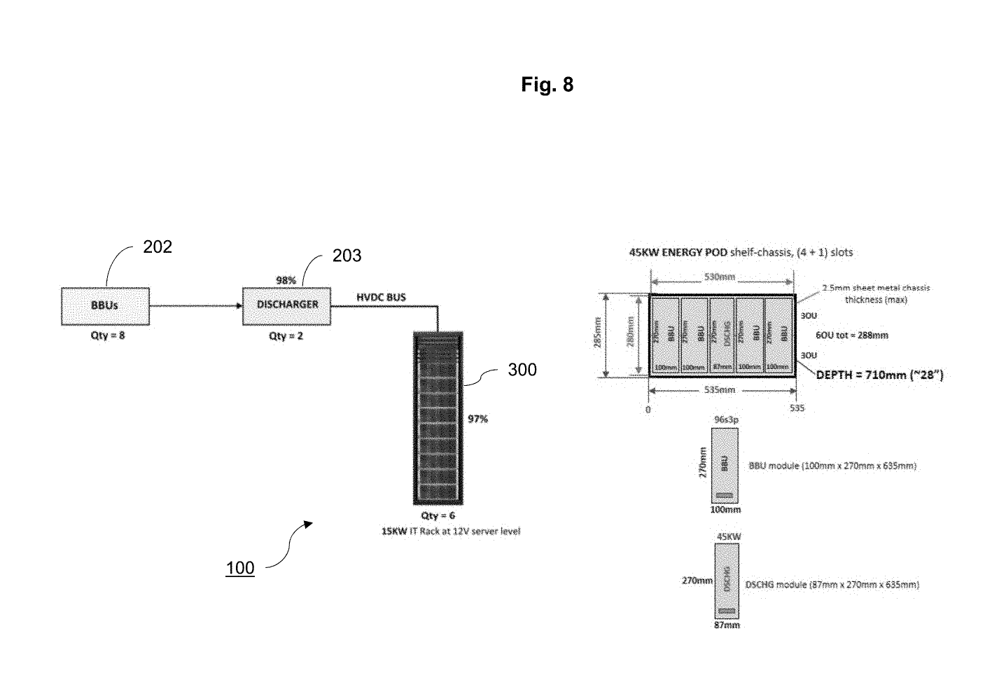

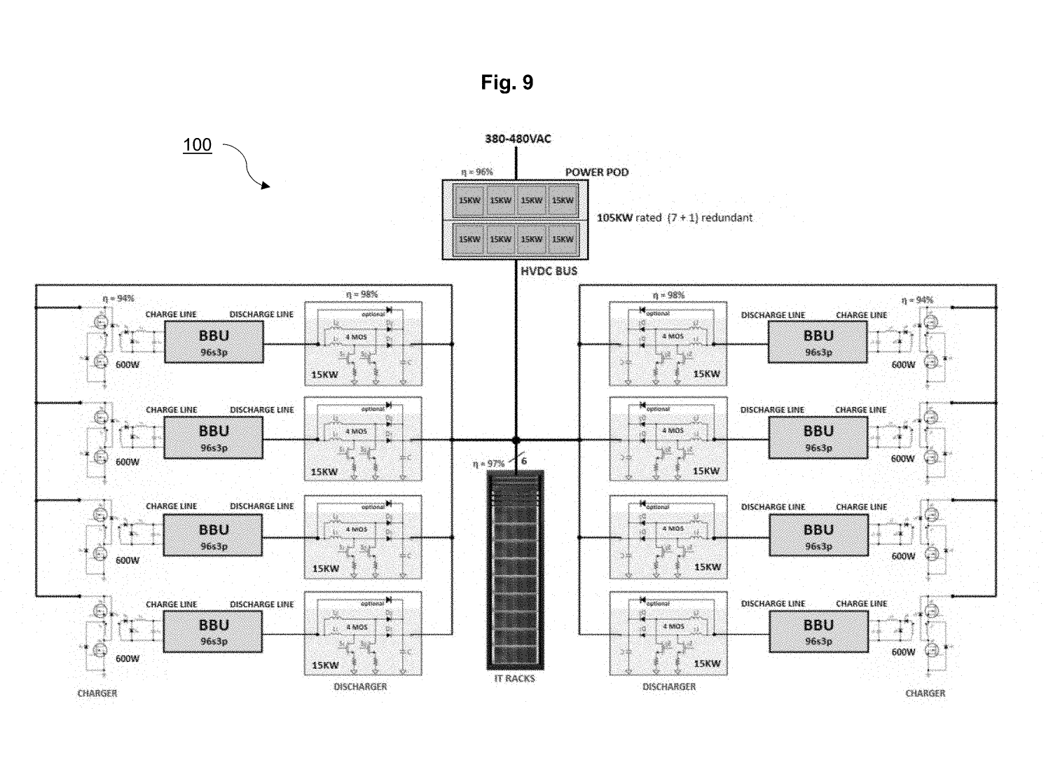

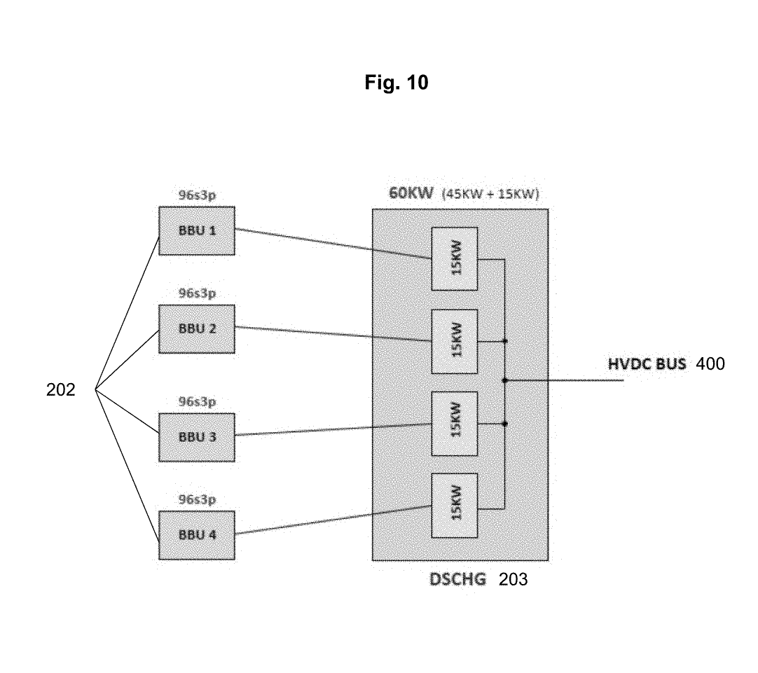

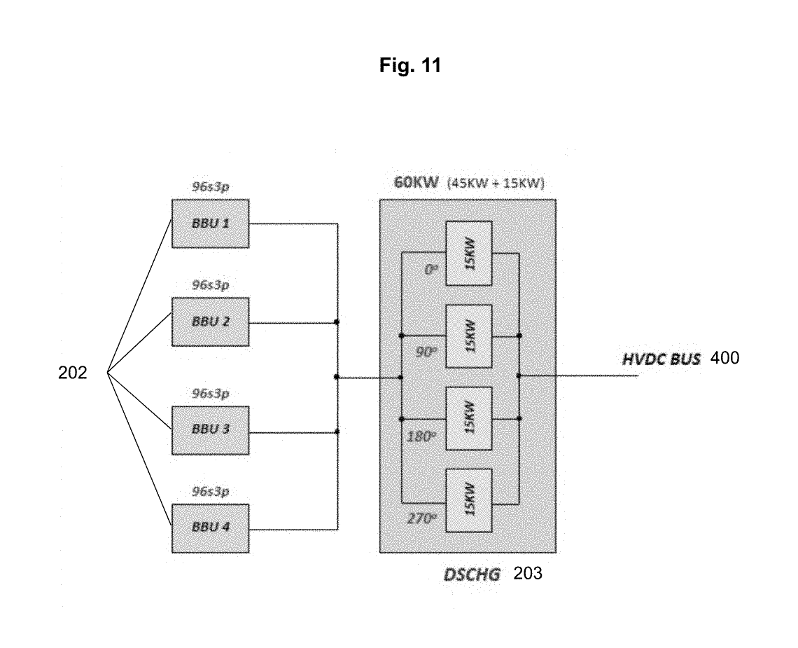

With this configuration, for example, one HVDC cabinet (e.g., the cabinet 500) powers two rack PODs (e.g., the system power domain 200A and 200B), each POD composed of six racks: e.g., (6×15 KW)=90 KW, with POD peak power capability as high as (90 KW+50%)=135 KW during surge mode. A fully deployed assembly of the cabinet 500 and the data center racks 300 are shown in FIG. 6. Each system power domain can be organized such as shown in FIGS. 7-11. Specifically, FIGS. 8-11 further illustrate exemplary embodiments for coupling the batteries 202 with the optional discharger (e.g., the intermediate converter 203) within each system power domain 200. FIGS. 9-10 illustrate the preferred embodiment of connecting the output of each battery 202 to the input of each of the four channels of the optional discharger (e.g., the intermediate converter 203). FIG. 11 illustrates an alternative embodiment wherein the output of each battery 202 is connected in parallel (with no shared BBU current), which parallel connection is coupled in series to a single input of the optional discharger (e.g., the intermediate converter 203).

In some embodiments, handling batteries 202 so they can be kept charged, releasing power during an AC power grid outage, and/or adding extra energy during POD surge mode events (peak power demands above POD rating) includes the following process:

The cabinet 500 includes converter modules to produce HVDC from an AC input power grid, the batteries 202, and also further power converter modules called ‘DSCHG’ (the optional discharger module, the charger module, and/or the intermediate converter 203). These DSCHG modules are optional but can be used for best system performances as desired. The convertor modules can be embedded into the cabinet 500. The DSCHG can advantageously be used to keep the individual battery backup BBU modules charged (charging them properly and individually) and to keep the voltage across the HVDC busway 400 regulated during the discharge of the batteries 202 following an AC outage (backup sequence), or during surge mode. In fact, the DC-DC power converters installed in the IT racks (necessary to produce low voltage, e.g., 12 VDC for servers and IT gears) can be designed very efficiently and inexpensively provided that HVDC input voltage variation is limited: this issue is solved by using the DSCHG modules that keep HVDC bus voltage regulated during batteries discharge.

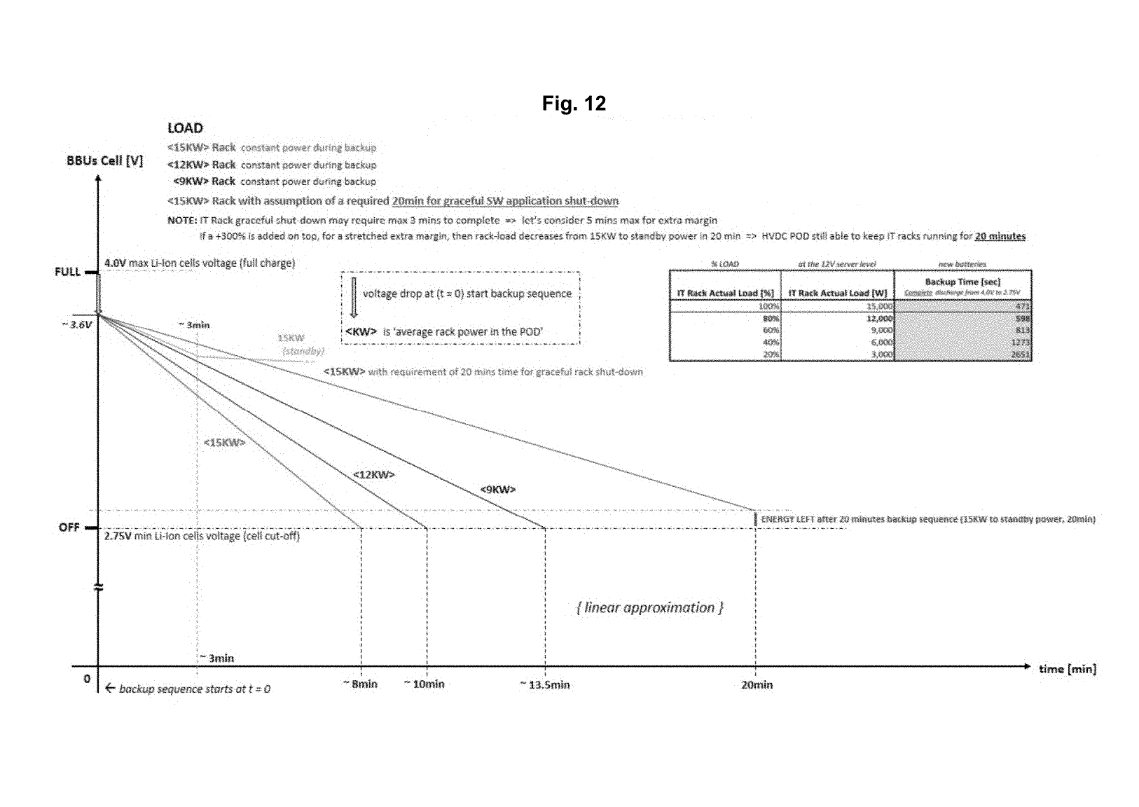

As another advantage of a DSCHG, during backup sequences or surge modes, the HVDC current in the busway never exceeds the max rating; being the load at constant power, lower bus voltages cause higher currents. This can be important when data center bus-bar power distribution and breakers are sized to avoid unwanted breakers tripping, for correct provisioning, to limit power and voltage loss during backup sequence or surge mode, and to avoid distribution bus overheat. In fact, without the DSCHG modules, the HVDC voltage during backup sequence or surge mode (events supported by the batteries) would lower substantially with the electrical current increasing in the opposite direction (batteries slowly discharge to lower voltages while load power remains constant). Furthermore, the DSCHG allows control of the battery modules to discharge current individually (optimum BBUs discharge current share), and make the application safer because no HVDC voltage from BBUs can reach cross slots in the rack (blocked by DSCHG). FIG. 12 is an exemplary chart illustrating the voltage of the batteries 202 for various loads during an exemplary backup sequence. Specifically, FIG. 12 illustrates the approximate discharge time of the batteries 202 as a function of load. Those of ordinary skill in the relevant art will appreciate that the IV characteristic is plotted linearly for simplicity only. As shown in FIG. 12, the lower the load of the data center rack 300, the longer the backup time using the same batteries 202.

The DSCHG can engage surge mode functions by sharing output current with the output of the AC-DC HVDC converter during surge mode.

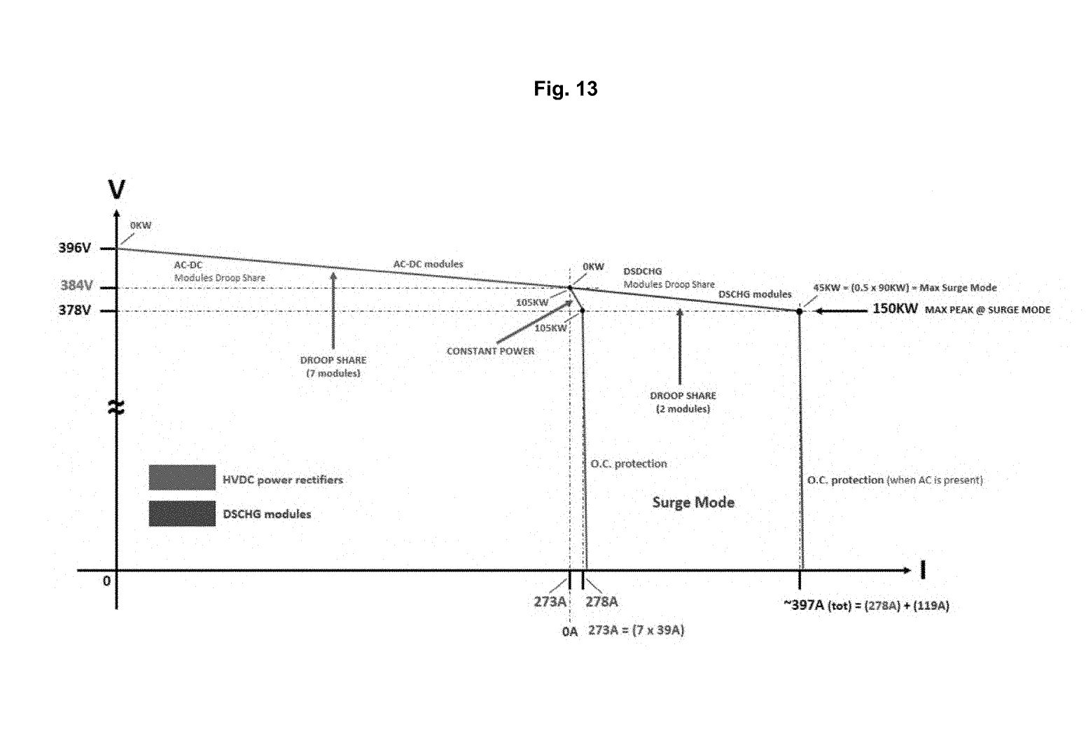

This DSCHG ‘discharge converter and battery charger’ is normally OFF (or standby), thereby maximizing electrical efficiency during online operations. An exemplary current-voltage (IV) characteristic of the system power domain 200 during surge mode is shown in FIG. 13. As shown, in the surge mode phase, the AC rectifier from the AC power grid is already at full power while extra power is provided by the optional DSCHG module powered by the batteries 202. In this example, both the AC power grid and the batteries 202 provide power to the data center racks 300 in the surge mode function. In other words, surge mode is automatically triggered, and extra energy is supplied by the batteries 202. The individual rack power peaks may be as high as +50% nominal (e.g., +50% above the maximum 90 KW system power domain 200, yielding an extra 45 KW for a total of 135 KW).

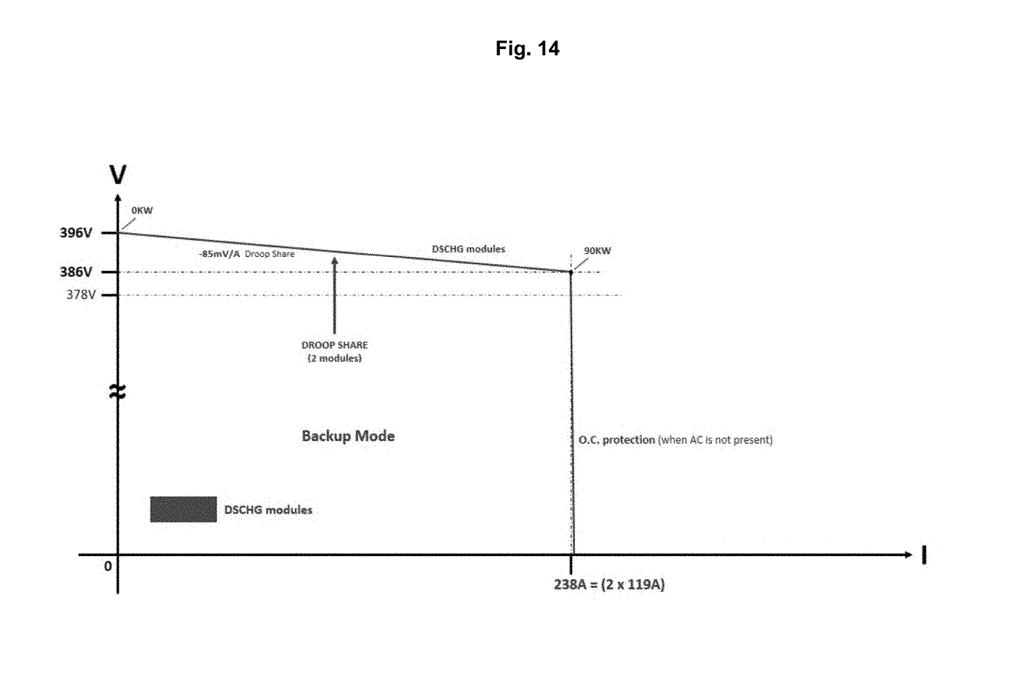

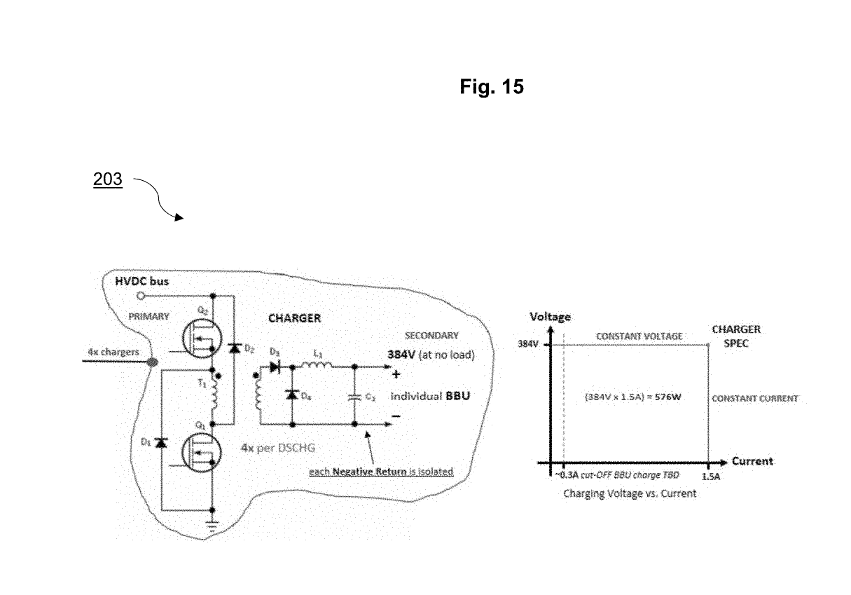

An exemplary current-voltage (IV) characteristic of the system power domain 200 during backup mode is shown in FIG. 14. With reference to FIG. 14, the output voltage of two optional dischargers (e.g., two intermediate converters 203), for example, in parallel, are shown as a function of the load. The voltage of the batteries 202 at the output of the discharger modules during an AC power grid outage is shown. FIG. 15 illustrates an exemplary circuit diagram for implementing the charger (e.g., the intermediate converter 203). As shown, the battery charger includes a two-transistor forward converter with a precise output voltage and a precise over-current threshold. However, those of ordinary skill in the art will recognize that this example circuit design is merely illustrative and variations of circuit designs are within the scope of the systems and methods described herein. As also shown in FIG. 15, an exemplary IV characteristic of the charger (e.g., the intermediate converter 203) is shown illustrating the charging voltage versus the charging current.

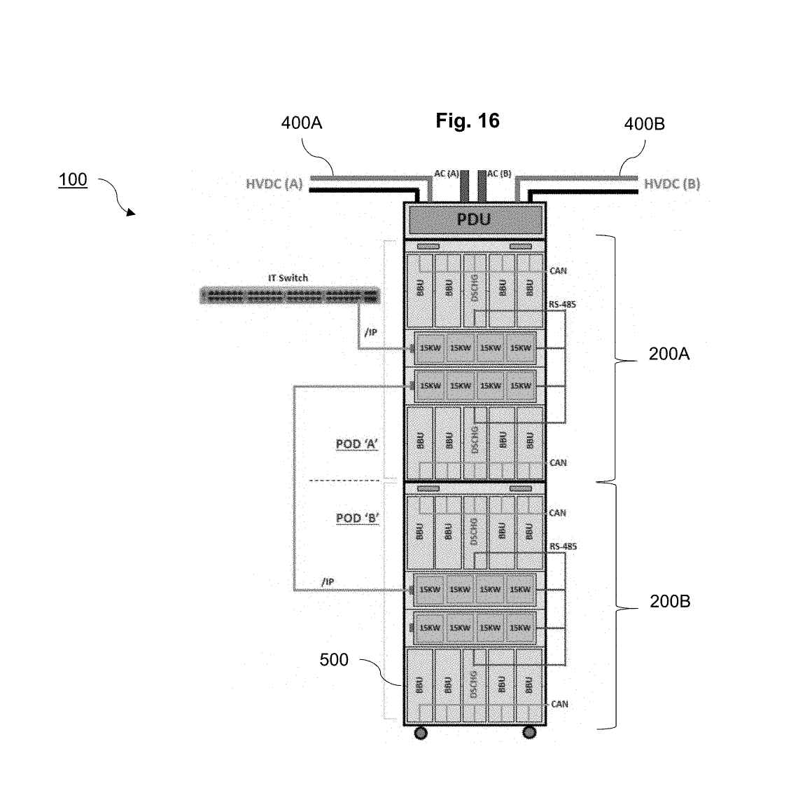

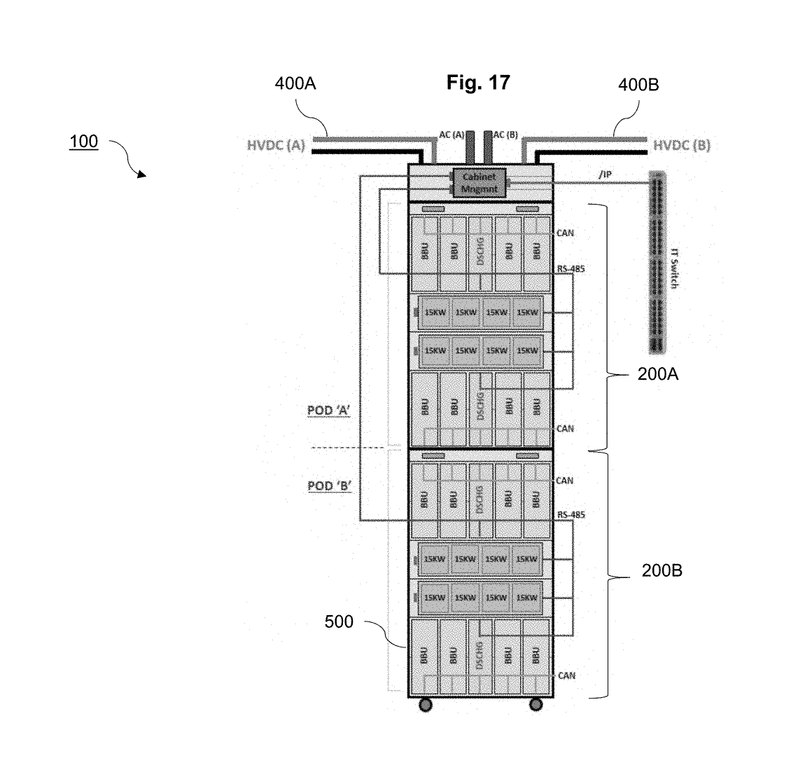

FIG. 16 shows one embodiment of a digital interconnection topology for a high voltage direct current (HVDC) cabinet 500 using the power management system of FIG. 1. The HVDC cabinet 500 of FIG. 16 is shown without a local cabinet management controller. Additionally and/or alternatively, the HVDC cabinet 500 can include a local cabinet management controller, such as shown in FIG. 17.

The power management system 100 can also be implemented by paralleling the batteries directly to the HVDC BUS. In this case the battery chargers would sit directly inside the battery modules and DSCHG modules are not required. This embodiment can be simpler and cheaper, but can sacrifice desirable system performances and safety guards, as previously explained.

The power management system 100 advantageously provides seamless continuity of power to the IT racks after any input AC power grid loss or sudden sags by using an alternative HVDC (High Voltage Direct Current) approach with local batteries, and fractioning the power domains to multiple independent cells called ‘PODs’. One POD of IT racks can be for example 6 racks, with each rack rated for example 15 KW (max).

Another advantage of the power management system 100 is a much higher electrical efficiency (cheaper power bill), a much lower up-front capital expenditure cost for implementation and deployment, and lower maintenance cost vs. the classical AC Universal Power Supply (UPS). Finally, grouping battery banks together for all racks in the PODs allows to efficiently use the energy stored in the batteries; in fact, power consumption of individual racks in the POD varies and cannot be controlled.

The power management system 100 also allows the racks to temporarily use up to +50% rack power on top of their normal max load rating (power converters installed in the IT racks are sized accordingly). This can happen because the source of power is consolidated and shared among all the racks belonging to the same POD (e.g., same row), so racks with lower consumption can give excess power to other racks in same POD that momentarily need more power (Peak Sharing); or even using battery banks charged at the HVDC voltage to compensate for power peaks exceeding the POD power rating itself (Surge Mode) while the energy from AC power grid would stay capped to the max provisioned value (Peak Shaving).

Moving out from IT racks into data center infrastructure part of the power conversion circuitry normally included in the racks, reduces cost overtime because racks are swapped in average every three years due to new generation of IT gears getting available (when this happens, rack frame and in-rack (or in-chassis) power converters also get disposed). With this approach, part of the power converters are not disposed with the racks (specifically the PFC circuitry (Power Factor Correction) and all of the related front-end AC circuitry of the server power supply), rather that stays in the data center infrastructure indefinitely in a consolidated fashion, until failure (note: the presently disclosed system can include redundancy). This is a winning cost amortization model, a substantial reduction of IT rack power cost over time.

Depending on how much battery capacity is installed, the power management system 100 facilitates the data center power provisioning in the sense that ‘Peak Shaving’ functionality pushes the <average used power> value towards the <peak provisioned power> value, because of the dumping factor provided by the battery banks that are connected to the HVDC bus. The AC input power from the grid can be capped (Peak Shaving) and so AC power cannot surpass the provisioned value. Stated in another way, the AC grid power provisioning, which usually equals the peak load and not to the average load, can be sized with precision and utilized in its fullness, with substantial cost savings. In fact, the power management system 100 compresses the ‘average power’ to ‘peak power’, so that the difference of the ‘AC peak power provisioned’ and the ‘AC average power used’ is minimized.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

Accordingly, persons of ordinary skill in the relevant art will understand that, although particular embodiments have been described, the principles described herein can be applied to different types of environments and solutions. Certain embodiments have been described for the purpose of simplifying the description, and it will be understood to persons skilled in the art that this is illustrative only. It will also be understood that reference to particular hardware or software terms herein can refer to any other type of suitable device, component, software, and so on. Moreover, the principles discussed herein can be generalized to any number and configuration of devices and protocols, and can be implemented using any suitable type of digital electronic circuitry, or in computer software, firmware, or hardware. Accordingly, while this specification highlights particular implementation details, these should not be construed as limitations on the scope of any invention or of what may be claimed, but rather as descriptions of features that may be specific to particular embodiments of particular systems.

What is claimed is:

1. A high-voltage direct current (HVDC) power domain for one or more data center racks, comprising:
a system power domain for receiving input from an alternating current (AC) power grid; and
an HVDC busway for receiving a direct current from the system power domain for powering the one or more data center racks,
wherein the system power domain consolidates server power outside of the one or more data center racks and comprises:
an HVDC shelf for generating the direct current from the AC power grid; and
one or more batteries in operable connection to the HVDC shelf.

2. The HVDC power domain of claim 1, wherein the one or more batteries are coupled to the HVDC busway via one or more intermediate converters and one or more battery dischargers.

3. The HVDC power domain of claim 1, wherein the HVDC shelf comprises one or more redundant high-power rectifiers.

4. The HVDC power domain of claim 1, wherein the one or more data center racks comprise one or more information technology racks.

5. The HVDC power domain of claim 1, wherein the system power domain receives 380-480 VAC input from the AC power grid.

6. The HVDC power domain of claim 5, wherein said HVDC shelf produces at least 380 VDC from the AC power grid across the HVDC busway.

7. The HVDC power domain of claim 1, wherein the one or more batteries are Lithium Ion battery backup units.

8. The HVDC power domain of claim 1, wherein the system power domain operates in at least one of a peak sharing mode, a surge mode, and a peak shaving mode.

9. The HVDC power domain of claim 1, wherein the one or more batteries comprise three arrays in parallel, each array comprising ninety-six Li-Ion cells in series.

10. A high-voltage direct current (HVDC) cabinet for one or more data center racks, comprising:
at least two system power domains for receiving input from an alternating current (AC) power grid; and
an HVDC busway for receiving a direct current from at least one of the system power domains for powering the one or more data center racks,
wherein each system power domain consolidates server power outside of the one or more data center racks and comprises:
an HVDC shelf for generating the direct current from the AC power grid; and
one or more batteries in operable connection to the HVDC shelf.

11. The HVDC cabinet of claim 10, wherein the one or more batteries are coupled to the HVDC busway via one or more intermediate converters and one or more battery dischargers.

12. The HVDC cabinet of claim 11, wherein an output for each of the one or more batteries is connected in series to the one or more battery dischargers.

13. The HVDC cabinet of claim 11, wherein an output for each of the one or more batteries is connected in parallel, the batteries in parallel is coupled in series to a single input of the one or more battery dischargers.

14. The HVDC cabinet of claim 10, wherein the cabinet is an open rack.

15. The HVDC cabinet of claim 10, wherein each system power domain powers a unique set of the one or more data center racks.

16. The HVDC cabinet of claim 10, further comprising an AC breaker hard-wired to the AC power grid and for regulating the input to each of the system power domains.

17. The HVDC cabinet of claim 10, further comprising a solid-state switch for interconnecting the system power domains.

18. The HVDC cabinet of claim 17, wherein the solid-state switch is a bi-directional solid switch having a 45 KW rating.

19. The HVDC cabinet of claim 10, further comprising a soft switch for each of the system power domains for turning off the batteries associated with a selected system power domain.

20. The HVDC cabinet of claim 10, wherein each HVDC shelf comprises one or more redundant high-power rectifiers.
